(19) United States
(12) Patent Application Publication
(10) Pub. No.: US 2025/0283521 A1
(43) Pub. Date: Sep. 11, 2025

(54) INTELLIGENT VIBRATION ISOLATOR AND CONTROL METHOD THEREOF

(71) Applicant: Changsha University of Science and Technology, Changsha (CN)

(72) Inventors: Lidong WANG, Changsha (CN); Yan HAN, Changsha (CN); Peng HU, Changsha (CN); Chunguang LI, Changsha (CN); Ying LUO, Changsha (CN); Hanyun LIU, Changsha (CN); Ziqiang LI, Changsha (CN); Xiumeng BU, Changsha (CN); Shaoling DING, Changsha (CN); Min ZENG, Changsha (CN)

(73) Assignee: Changsha University of Science and Technology, Changsha (CN)

(21) Appl. No.: 18/751,790

(22) Filed: Jun. 24, 2024

(30) Foreign Application Priority Data
Mar. 8, 2024 (CN) 202410263611.9

(51) Int. Cl. F16F 15/03; F16F 1/36

(52) U.S. Cl. CPC F16F 15/035; F16F 1/361; F16F 2222/06; F16F 2228/063; F16F 2228/066; F16F 2230/0094; F16F 2230/18

(57) ABSTRACT

Disclosed are an intelligent vibration isolator and a control method thereof. The intelligent vibration isolator includes a base, a vibration isolation mechanism disposed inside the base, and a controller; the base includes a bottom plate and a supporting sleeve disposed on the bottom plate; the vibration isolation mechanism includes a load platform, a supporting platform, a magnetorheological elastomer and an electromagnet which are sequentially and coaxially disposed from top to bottom; the vibration isolation mechanism is provided with at least three negative stiffness mechanisms that are uniformly distributed in a circumferential direction of the supporting platform; a strain detection device is disposed on an outer wall of the magnetorheological elastomer; and the controller adjusts and controls a magnitude of current of the electromagnet according to a received strain magnitude to control vertical stiffness of the isolator, and make the intelligent vibration isolator always be in a quasi-zero stiffness state.

### CROSS-REFERENCE TO RELATED APPLICATIONS

This application claims priority to Chinese Patent Application No. 202410263611.9, filed on Mar. 8, 2024, the content of which is incorporated herein by reference in its entirety.

### TECHNICAL FIELD

The present disclosure relates to the technical field of vibration reduction, and particularly relates to an intelligent vibration isolator and a control method thereof.

### BACKGROUND

Vibration phenomena are widely present in daily life and engineering applications, and the impact arising therefrom cannot be ignored. Therefore, a vibration isolator has become an essential tool for vibration reduction. For a traditional linear vibration isolation system, external excitation frequency must be greater than \sqrt{2} times of natural frequency of the system to make the system have effective performance of vibration isolation. In order to effectively broaden a frequency band of the vibration isolation, the natural frequency needs to be reduced. However, reduction of the natural frequency of the system will lead to a decrease in stiffness, thereby reducing the load-bearing capacity of the system. A quasi-zero stiffness isolator has the characteristics of high static and low dynamic stiffness. When a load is zero, the isolator possesses high static stiffness (load-bearing stiffness) to ensure load capacity and small static displacement. When the load compresses the isolator to a static equilibrium position, the dynamic stiffness of the isolator is significantly reduced. Therefore, the isolator balances high load-bearing capacity and low natural frequency, effectively addressing the bottleneck problem of passive vibration isolation. However, the traditional quasi-zero stiffness isolator exhibits poor adaptability to the load and cannot restore to a quasi-zero stiffness state when the load changes.

Therefore, there is an urgent need for an intelligent vibration isolator and a control method thereof capable of restoring to the quasi-zero stiffness state when the load changes.

### SUMMARY

In view of the existing problems, it is necessary to provide an intelligent vibration isolator and a control method thereof to solve the problems that the traditional quasi-zero stiffness isolator is incapable of restoring to a quasi-zero stiffness equilibrium state when a load changes.

In a first aspect, an embodiment of the present disclosure provides an intelligent vibration isolator, including a base, a vibration isolation mechanism disposed inside the base, and a controller.

The base includes a bottom plate and a supporting sleeve disposed on the bottom plate.

The vibration isolation mechanism includes a load platform, a supporting platform, a magnetorheological elastomer and an electromagnet which are sequentially and coaxially disposed from top to bottom.

The vibration isolation mechanism is provided with at least three negative stiffness mechanisms, one end of each of the negative stiffness mechanism is hinged to an outer wall of the supporting platform, and the other end thereof is hinged to an inner wall of the supporting sleeve, and the at least three negative stiffness mechanisms are uniformly distributed in a circumferential direction of the supporting platform between the inner wall of the supporting sleeve and the outer wall of the supporting platform.

The electromagnet is disposed in a middle of the bottom plate and is electrically connected to the controller.

A strain detection device is disposed on an outer wall of the magnetorheological elastomer for detecting strain magnitude generated by the magnetorheological elastomer in real time and feeding the strain magnitude back to the controller.

The controller adjusts and controls a magnitude of current of the electromagnet in real time according to the received strain magnitude to control vertical stiffness of the intelligent vibration isolator, and make the intelligent vibration isolator always be in the quasi-zero stiffness equilibrium state; and
where the magnetorheological elastomer is a variable positive stiffness mechanism and is connected in parallel to the negative stiffness mechanisms to form a quasi-zero stiffness system of the intelligent vibration isolator.

Preferably, each negative stiffness mechanism includes a telescopic rod assembly and a spring sleeved outside the telescopic rod assembly, the telescopic rod assembly has a first end and a second end disposed opposite to each other, the first end of the telescopic rod assembly is hinged to the outer wall of the supporting platform, and the second end of the telescopic rod assembly is hinged to the inner wall of the supporting sleeve.

Preferably, the telescopic rod assembly includes a first supporting rod and a second supporting rod, and the second supporting rod is slidably disposed inside the first supporting rod in an axis direction of the first supporting rod.

Preferably, the electromagnet includes a supporting iron core and a coil wound around an outer wall of the supporting iron core; and the supporting iron core is a cylindrical structure, a side wall groove is formed on a side wall of the supporting iron core in a circumferential direction of the supporting iron core, and the coil is wound inside the side wall groove; and
a top groove is formed on a top of the supporting iron core, one end of the magnetorheological elastomer is disposed inside the top groove, and the other end of the magnetorheological elastomer is connected to the supporting platform.

Preferably, a first hinge seat is disposed on the outer wall of the supporting platform, a first pin shaft is rotatably disposed on the first hinge seat, and the first end of the telescopic rod assembly is connected to the first pin shaft; and
a second hinge seat is correspondingly disposed on the inner wall of the supporting sleeve, a second pin shaft is rotatably disposed on the second hinge seat, and the second end of the telescopic rod assembly is connected to the second pin shaft.

In a second aspect, an embodiment of the present disclosure provides a control method for an intelligent vibration isolator, including the following steps.
S1: when the load on the load platform changes, the strain detection device obtains the strain magnitude ε(t) of the magnetorheological elastomer in real time, and the negative stiffness mechanism is in a disequilibrium position; and
S2: adjusting the magnitude of current of the electromagnet to change a stiffness value of the magnetorheological elastomer until the strain magnitude ε(t) obtained in the step S1 approaches a target strain magnitude ε, the negative stiffness mechanism restores the equilibrium position, and the intelligent vibration isolator is in the quasi-zero stiffness equilibrium state.

Preferably, in the step S2, the magnitude of current of the electromagnet is adjusted through a Proportional-Integral-Derivative (PID) algorithm, and the PID algorithm includes the following steps.
obtaining a strain magnitude ε of the magnetorheological elastomer when the intelligent vibration isolator is in an initial quasi-zero stiffness equilibrium state, and setting the strain magnitude as a target strain magnitude;
calculating and adjusting an output current (u(t)) according to the following formula:

$$u ( t ) = {k}_{P} e ( t ) + {k}_{I} \int e ( t ) dt + {k}_{d} \frac{de ( t )}{dt} ;$$

where e(t) represents a strain magnitude error signal of the magnetorheological elastomer, e(t)=ε(t)−ε; and k_{P} represents a proportional coefficient, k_{I} represents an integral coefficient, and k_{d} represents a differential coefficient.

Preferably, in the step S2, when the strain magnitude ε(t) obtained in real time is less than the target strain magnitude ε, stiffness of the magnetorheological elastomer is too large, in which case, a current value is sequentially reduced until the strain magnitude ε(t) approaches the target strain magnitude ε; and
when the strain magnitude ε(t) obtained in real time is greater than the target strain magnitude ε, the stiffness of the magnetorheological elastomer is too small, in which case, the current value is sequentially increased until the strain magnitude ε(t) approaches the target strain magnitude ε.

Preferably, a single current reduction value is set to 0.1 A, and a single current increase value is set to 0.1 A.

Compared with the prior art, the present disclosure has the following beneficial effects.

Firstly, from a structural perspective, the magnetorheological elastomer structure capable of generating variable positive stiffness is connected to the negative stiffness mechanism in the present disclosure to form the quasi-zero stiffness system of the intelligent vibration isolator, since the electromagnet is disposed directly below the magnetorheological elastomer, stiffness characteristics of the magnetorheological elastomer can be adjusted by regulating a controllable magnetic field generated by applied current of the electromagnet; and when load changes, the magnitude of current is adjusted to change rigidity of the magnetorheological elastomer, such that the intelligent vibration isolator always maintains the quasi-zero stiffness equilibrium state; and meanwhile, the outer wall of the magnetorheological elastomer is further provided with the strain detection device capable of obtaining the strain of the magnetorheological elastomer in real time and thereby determining a position of the negative stiffness mechanism of the intelligent vibration isolator; when the load changes, the vibration isolator will leave an equilibrium position and move away from the quasi-zero stiffness equilibrium state without adjusting the magnitude of current, which loses the advantage of high static stiffness and low dynamic stiffness, and the arrangement of the strain detection device can determine whether the vibration isolator is in the quasi-zero stiffness equilibrium state in real time; since the strain magnitude measured by the strain detection device is a fixed value when the vibration isolator is in the quasi-zero stiffness equilibrium state, that is, the magnitude of compression deformation of the magnetorheological elastomer is constant when the vibration isolator is loaded from zero to a quasi-zero stiffness equilibrium state, therefore, it is simple and reliable to measure a vibration isolation state of the vibration isolator is monitored in real time through the strain detection device, and even if the load changes, the intelligent vibration isolator can still return to the quasi-zero stiffness equilibrium state, thereby ensuring that the intelligent vibration isolator is always in the quasi-zero stiffness equilibrium state.

Lastly, from a method perspective, the present disclosure provides a control method for an intelligent vibration isolator, when the load on the load platform changes, the strain detection device obtains the strain magnitude ε(t) of the magnetorheological elastomer in real time, and the negative stiffness mechanism is in a disequilibrium position; the magnitude of current of the electromagnet is adjusted to change the stiffness value of the magnetorheological elastomer until the strain magnitude ε(t) approaches a target strain magnitude ε, the negative stiffness mechanism restores the equilibrium position, and the intelligent vibration isolator is in the quasi-zero stiffness equilibrium state; specifically, an applied controllable magnetic field is by adjusting the magnitude of current on the electromagnet at a bottom of the magnetorheological elastomer, to enable the intelligent vibration isolator to return to the quasi-zero stiffness equilibrium state when the load changes, and when the load is increased, the current will be increased to improve vertical stiffness of the intelligent vibration isolator; when the load is reduced, the current is reduced to reduce the vertical stiffness of the intelligent vibration isolator, thereby ensuring that the magnetorheological elastomer has the same magnitude of compression deformation when the load changes, that is, the intelligent vibration isolator can always maintain the quasi-zero stiffness equilibrium state; consideration is only given to the relationship between the strain magnitude and the current of the adjustment process, without paying attention to additional parameters, and the target strain magnitude is approached by the adjustment of the magnitude of current value, such that the purposes of simple and convenient control, rapid response are achieved, and real-time control and adjustment are finally implemented to maintain the intelligent vibration isolator in the quasi-zero stiffness equilibrium state.

### BRIEF DESCRIPTION OF THE DRAWINGS

Exemplary embodiments of the present disclosure may be more fully understood by reference to the following drawings. The accompanying drawings are used for providing further understanding of embodiments in the present disclosure, and constitute part of the specification, used, together with embodiments of the present disclosure, to explain the present disclosure and are not to be construed as limiting the present disclosure. In the drawings, like reference numerals generally represent like components or steps.

FIG. 1 is a three-dimensional schematic diagram of an intelligent vibration isolator according to the present disclosure.

FIG. 2 is a schematic diagram of an intelligent vibration isolator in a quasi-zero stiffness equilibrium state according to the present disclosure.

FIG. 3 is a schematic diagram of a three-dimensional structure of a negative stiffness mechanism of an intelligent vibration isolator according to the present disclosure.

FIG. 4 is a schematic sectional diagram of a positive stiffness mechanism of a magnetorheological elastomer according to the present disclosure.

FIG. 5 is a schematic diagram of a magnetorheological effect of a magnetorheological elastomer according to the present disclosure, where (a) of FIG. 5 is a schematic diagram of random distribution, and (b) of FIG. 5 is a schematic diagram of a magnetically induced chain.

FIG. 6 is a flow chart of a control method of an intelligent vibration isolator according to the present disclosure.

FIG. 7 is a schematic diagram of control principles of an intelligent vibration isolator controlled by a PID algorithm according to the present disclosure.

### DETAILED DESCRIPTION OF THE EMBODIMENTS

Exemplary embodiments of the present disclosure will be described in more detail below with reference to the accompanying drawings. Although exemplary embodiments of the present disclosure are shown in the drawings, it should be understood that the present disclosure may be embodied in various forms and should not be limited by the embodiments set forth herein. Rather, these embodiments are provided for more thorough understanding of the present disclosure and to fully convey the scope of the present disclosure to those skilled in the art.

In the description of the present disclosure, it is to be noted that orientation or position relations indicated by the terms “central”, “upper”, “lower”, “left”, “right”, “vertical”, “horizontal”, “inner”, “outer”, etc. are based on orientation or position relations shown in the accompanying drawings, and are merely for facilitating the description of the present disclosure and simplifying the description, rather than indicating or implying the device or element referred to must have a specific orientation or be constructed and operated in a specific orientation, and therefore will not be interpreted as limiting the present disclosure. In addition, the terms “first”, “second” and “third” are for descriptive purposes only and should not be construed as indicating or implying relative importance.

In the description of the present disclosure, it should be noted that, unless otherwise explicitly specified and defined, the terms “mounting”, “connecting” and “connection” should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. For those of ordinary skill in the art, the specific meanings of the above terms in the present disclosure may be understood according to specific circumstances.

Further, the technical features involved in different implementations of the present disclosure described below may be combined with one another as long as they do not constitute a conflict with one another.

### Embodiment 1

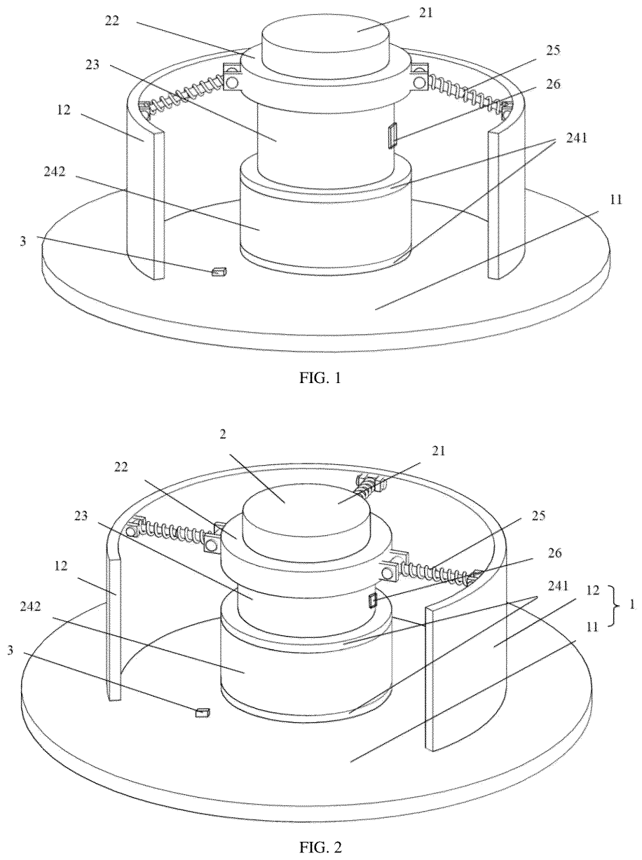

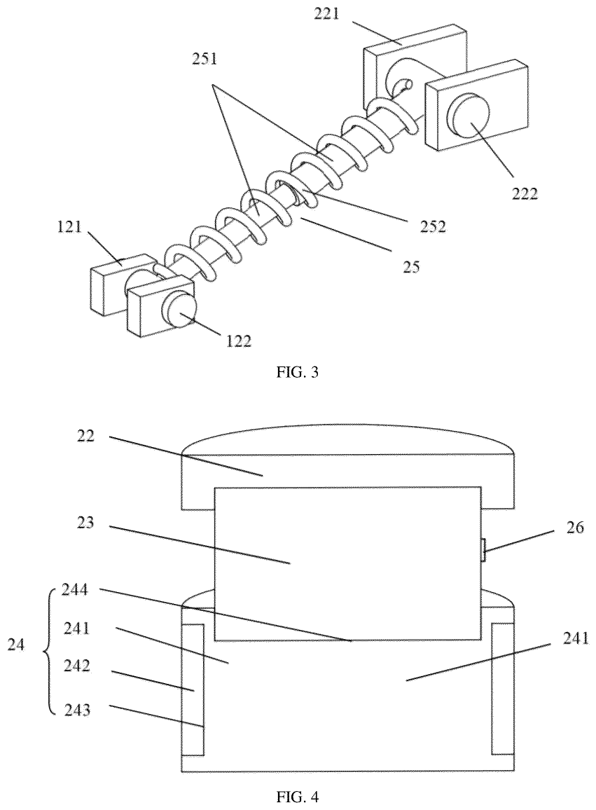

With reference to FIGS. 1-5, the present disclosure provides an intelligent vibration isolator, including a base 1, a vibration isolation mechanism 2 disposed inside the base 1, and a controller 3.

Specifically, the base 1 includes a bottom plate 11 and a supporting sleeve 12 disposed on the bottom plate 11.

Specifically, the vibration isolation mechanism 2 includes a load platform 21, a supporting platform 22, a magnetorheological elastomer 23 and an electromagnet 24 which are sequentially and coaxially disposed from top to bottom.

Specifically, the vibration isolation mechanism 2 further includes a negative stiffness mechanism 25, one end of the negative stiffness mechanism 25 is hinged to an outer wall of the supporting platform 22, and the other end thereof is hinged to an inner wall of the supporting sleeve 12.

Specifically, the electromagnet 24 is disposed in a middle of the bottom plate 11 and is electrically connected to the controller 3; the electromagnet 24 disposed in the middle of the bottom plate 11 and the magnetorheological elastomer 23 form a positive stiffness mechanism capable of generating variable positive stiffness, and the positive stiffness mechanism and the negative stiffness mechanism 25 are connected in parallel to form a quasi-zero stiffness system of the intelligent vibration isolator.

Specifically, a strain detection device 26 is disposed on an outer wall of the magnetorheological elastomer 23 for detecting strain magnitude generated by the magnetorheological elastomer in real time and feeding the strain magnitude back to the controller 3; the controller 3 adjusts and controls a magnitude of current of the electromagnet 24 in real time according to the received strain magnitude to maintain a quasi-zero stiffness equilibrium state of the intelligent vibration isolator; and in this embodiment, the strain detection device 26 includes a strain gauge attached to the outer wall of the magnetorheological elastomer 23 and a strain measurement device electrically connected to the strain gauge, and the strain measurement device calculates and obtains strain magnitude of the magnetorheological elastomer 23 according to signal changes on the strain gauge.

In this embodiment, since the electromagnet 24 is disposed directly below the magnetorheological elastomer 23, stiffness characteristics of the magnetorheological elastomer 23 can be adjusted by regulating a controllable magnetic field generated by applied current of the electromagnet 24; and when load changes, the magnitude of current (I)s adjusted to change rigidity of the magnetorheological elastomer 23, such that the intelligent vibration isolator returns to the quasi-zero stiffness equilibrium state again.

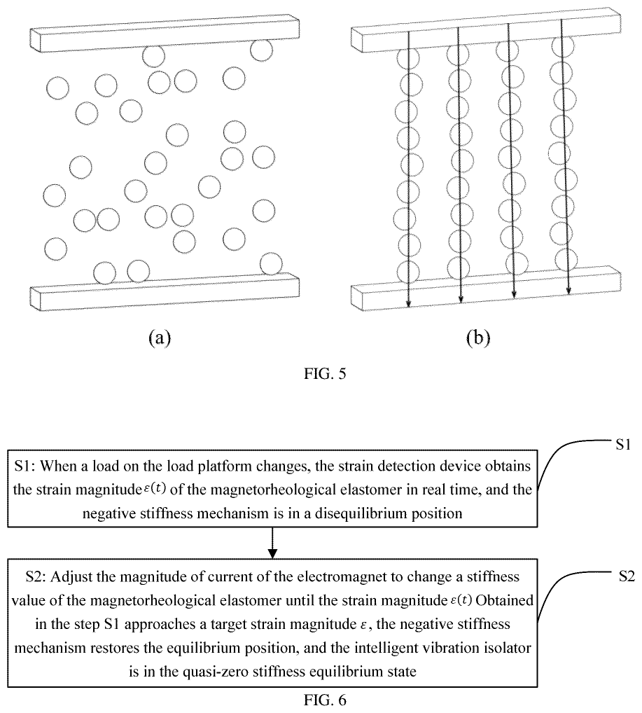

Specifically, the magnetorheological elastomer 23 generates magnetically induced damping and magnetically induced damping (that is, a magnetorheological effect, as shown in FIG. 5) under an applied magnetic field; in this embodiment, the magnetorheological elastomer 23 is in a shape of cylinder, the operating mode is tensile-compressive, the magnetorheological elastomer 23 can be compressed and deformed when the load platform 21 is loaded, and magnitude of compression deformation can be obtained in real time by the strain detection device 26 disposed on the outer surface of the magnetorheological elastomer 23; the electromagnet 24 can generate a magnetic field with controllable magnetic induction intensity according to magnitude of current introduced thereto, and the magnetic field will directly act on the magnetorheological elastomer 23 and change the stiffness characteristics thereof, finally resulting in changes in the magnitude of compression deformation generated by the magnetorheological elastomer 23 under the same load; otherwise, in the case of load changes, the magnitude of the current introduced into the electromagnet 24 can be adjusted, so as to obtain magnitude of compression deformation same as that of the magnetorheological elastomer 23.

Since the intelligent vibration isolator is provided with the electromagnet 24 directly below the magnetorheological elastomer 23, the stiffness characteristics of the magnetorheological elastomer 23 can be adjusted by regulating the controllable magnetic field generated by the applied current of the electromagnet 24; and when load changes, the magnitude of current (I)s adjusted to change rigidity of the magnetorheological elastomer 23, such that the intelligent vibration isolator returns to the quasi-zero stiffness equilibrium state again.

Further, in the present disclosure, the outer wall of the magnetorheological elastomer 23 is further provided with the strain detection device 26 capable of obtaining the strain of the magnetorheological elastomer in real time and thereby determining a position of the negative stiffness mechanism 25 of the intelligent vibration isolator; when the load changes, the vibration isolator will leave an equilibrium position and move away from the quasi-zero stiffness equilibrium state without adjusting the magnitude of current, which loses the advantage of high static stiffness and low dynamic stiffness, and the arrangement of the strain detection device 26 can determine whether the vibration isolator is in the quasi-zero stiffness equilibrium state in real time; since the strain magnitude measured by the strain detection device 26 is a fixed value when the vibration isolator is in the quasi-zero stiffness equilibrium state, that is, the magnitude of compression deformation of the magnetorheological elastomer 23 is constant when the vibration isolator is loaded from zero to the quasi-zero stiffness equilibrium state, therefore, it is simple and reliable to measure a vibration isolation state of the vibration isolator is monitored in real time through the strain detection device 26, and even if the load changes, the intelligent vibration isolator can still return to the quasi-zero stiffness equilibrium state, thereby ensuring that the intelligent vibration isolator is always in the quasi-zero stiffness equilibrium state.

As a preferred embodiment, the negative stiffness mechanism 25 includes a telescopic rod assembly 251 and a spring 252 sleeved outside the telescopic rod assembly 251, the telescopic rod assembly 251 has a first end and a second end disposed opposite to each other, the first end of the telescopic rod assembly 251 is hinged to the outer wall of the supporting platform 22, and the second end of the telescopic rod assembly is hinged to the inner wall of the supporting sleeve 12; and specifically, the telescopic rod assembly 251 includes a first supporting rod and a second supporting rod, and the second supporting rod is slidably disposed inside the first supporting rod in an axis direction of the first supporting rod.

An inclination angle of the telescopic rod assembly 251 in the negative stiffness mechanism 25 changes with the changes of the load on the load platform 21; specifically, when the load changes, the magnitude of compression deformation (that is, the strain magnitude) of the magnetorheological elastomer 23 also changes, a height of the supporting platform 22 disposed on an upper portion of the magnetorheological elastomer 23 also changes, the inclination angle of the telescopic rod assembly 251 hinged to the supporting platform 22 and capable of sliding and telescoping is also changed, referring to FIG. 2, and when the telescopic rod assembly 251 of the negative stiffness mechanism 25 is parallel to upper and lower surfaces of the bottom plate 11, the negative stiffness mechanism 25 is in an equilibrium position and exhibits its negative stiffness characteristics.

As a preferred embodiment, the vibration isolation mechanism 2 is provided with at least three negative stiffness mechanisms 25, which are uniformly distributed in a circumferential direction of the supporting platform 22 between the inner wall of the supporting sleeve 12 and the outer wall of the supporting platform 22; in this embodiment, four negative stiffness mechanisms 25 are provided and evenly distributed in the circumferential direction of the supporting platform 22 at intervals of 90°; and the first end of the telescopic rod assembly 251 of each negative stiffness mechanism 25 is hinged to the outer wall of the supporting platform 22, the second end thereof is hinged to the inner wall of the supporting sleeve 12, all negative stiffness mechanisms 25 cooperates with one another to provide the intelligent vibration isolator with negative stiffness, and are connected in parallel with positive stiffness provided by the magnetorheological elastomer 23 to achieve the quasi-zero stiffness equilibrium state of the intelligent vibration isolator.

As a preferred embodiment, the electromagnet 24 includes a supporting iron core 241 and a coil 242 wound around an outer wall of the supporting iron core 241; and the supporting iron core 241 is a cylindrical structure, a side wall groove 243 is formed on a side wall of the supporting iron core 241 in a circumferential direction of the supporting iron core, and the coil 242 is wound inside the side wall groove 243.

A top groove 244 is formed on a top of the supporting iron core 241, one end of the magnetorheological elastomer 23 is disposed inside the top groove 244, and the other end of the magnetorheological elastomer 23 is connected to the supporting platform 22; the arrangement of the side wall groove 243 of the supporting iron core 241 facilitates winding arrangement of the coil 242, such that a magnetic field with controllable magnetic induction intensity by controlling magnitude of current introduced to the coil 242; and the arrangement of the top groove 244 facilitates the arrangement of the magnetorheological elastomer 23, such that the generated magnetic field with the controllable magnetic induction intensity directly acts on the magnetorheological elastomer 23 and changes the stiffness characteristics thereof; and
when a load weight of load platform 21 changes, the controller 3 controls the loading current in the coil 242 to make the negative stiffness mechanism 25 return to the equilibrium position, thereby realizing the quasi-zero stiffness equilibrium state of the intelligent vibration isolator.

As a preferred embodiment, a first hinge seat 221 is disposed on the outer wall of the supporting platform 22, a first pin shaft 222 is rotatably disposed on the first hinge seat 221, and the first end of the telescopic rod assembly 251 is connected to the first pin shaft 222; and
a second hinge seat 121 is correspondingly disposed on the inner wall of the supporting sleeve 12, a second pin shaft 122 is rotatably disposed on the second hinge seat 121, and the second end of the telescopic rod assembly 251 is connected to the second pin shaft 122; and the arrangement of the hinge seats and the rotatable pin shafts facilitates the hinge between the telescopic rod assembly 251 and the supporting platform 22, as well as the supporting sleeve 12, such that the negative stiffness mechanism 25 provides reliable negative stiffness for the intelligent vibration isolator.

### Embodiment 2

With reference to FIG. 6, this embodiment provides a control method for an intelligent vibration isolator, including the following steps.
S1: when the load on the load platform 21 changes, the strain detection device 26 obtains the strain magnitude ε(t) of the magnetorheological elastomer 23 in real time, and the negative stiffness mechanism 25 is in a position; and
S2: adjust the magnitude of current of the electromagnet to change a stiffness value of the magnetorheological elastomer until the strain magnitude ε(t) obtained in the step S1 approaches a target strain magnitude ε, the negative stiffness mechanism restores the equilibrium position, and the intelligent vibration isolator is in the quasi-zero stiffness equilibrium state.

Specifically, an applied controllable magnetic field is generated by adjusting the magnitude of current on the electromagnet 24 at a bottom of the magnetorheological elastomer 23, to enable the intelligent vibration isolator to return to the quasi-zero stiffness equilibrium state when the load changes, and when the load is increased, the current will be increased to improve vertical stiffness of the intelligent vibration isolator; when the load is reduced, the current is reduced to reduce the vertical stiffness of the intelligent vibration isolator, thereby ensuring that the magnetorheological elastomer 23 has the same magnitude of compression deformation when the load changes, that is, the intelligent vibration isolator can always maintain the quasi-zero stiffness equilibrium state; consideration is only given to the relationship between the strain magnitude and the current of the adjustment process, and the target strain magnitude is approached by the adjustment of the magnitude of current value, such that the purposes of simple and convenient control, rapid response are achieved, and real-time control and adjustment can be implemented to maintain the intelligent vibration isolator in the quasi-zero stiffness equilibrium state.

In order to further describe that the control method provided by the present disclosure can still return to the quasi-zero stiffness equilibrium state again by adjusting the magnitude of current of the electromagnet 24 when the load changes, and the inventive concept of the present disclosure will be described below in conjunction with the characteristics of the magnetorheological elastomer 23, and the relationship between the deformation and the current.

Principle for variable stiffness of the magnetorheological elastomer 23 is as follows: after particles in the magnetorheological elastomer 23 are magnetized due to the magnetically induced of the magnetorheological elastomer 23 (as shown in FIG. 5), that is, under the action of the magnetic field, interaction force is generated. When the magnetorheological elastomer 23 is deformed, the magnetic force forms a reverse moment inside the magnetorheological elastomer, which enhances the ability of the material to resist deformation (that is, increase in stiffness), and the ability varies with the changes of the magnetic field. As the applied magnetic field increases, elastic modulus of the magnetorheological elastomer 23 becomes larger, and stiffness in a stress direction is also increased.

The control method provided by the present disclosure can realize the quasi-zero stiffness equilibrium state of the vibration isolator, with the working principle as follows.

The strain detection device 26 serves as a measuring element to monitor strain condition of the magnetorheological elastomer 23 of the intelligent vibration isolator in real time, and when a vertical length of the magnetorheological elastomer 23 is taken as an initial length when the intelligent vibration isolator is not loaded, the strain magnitude measured by the intelligent vibration isolator in real time is

$$ε = \frac{Δ L}{L}$$

(where L represents a vertical initial length of the magnetorheological elastomer 23, and ΔL represents changes in the length of the magnetorheological elastomer 23 due to changes in mass of an object carried on the load platform 21 and energized current (I) of the coil 242 of the electromagnet 24).

In order to make the intelligent vibration isolator reach the quasi-zero stiffness equilibrium state (as shown in FIG. 2), it should be ensured that when the mass of the carried object changes, the stiffness of the magnetorheological elastomer 23 can be changed by adjusting the magnitude of current, such that ΔL remains unchanged, that is, the strain magnitude ε obtained in real time after stabilization tends to a fixed value, which needs to balance the relationship between the mass of the carried object and the current of the coil 242. Specifically, in order to prevent the strain magnitude ε(t) from exceeding the standard, the current (I) of the coil 242 should be increased (to increase the stiffness of the magnetorheological elastomer 23); and when the mass of the carried object is reduced, the current (I) of the coil 242 should be reduced (the stiffness of the magnetorheological elastomer 23 becomes smaller) in order to make the strain magnitude ε(t) reach the standard.

The stiffness of the magnetorheological elastomer 23 changes along with the changes in the current of the coil 242, which can be expressed as follows:

$$K = {K}_{0} + Δ K \cdot \frac{I}{{I}_{0}} ; \qquad ( 1 )$$

where ΔK represents a magnetorheological effect coefficient, I₀ represents a reference current (a saturation effect occurs in case of exceeding I₀),

$${K}_{0} = {E}_{0} \cdot \frac{A}{L}$$

represents an initial stiffness of the magnetorheological elastomer 23) (E₀ represents an initial elastic modulus, A is a cross-sectional area, and L is an initial height).

The stiffness of the magnetorheological elastomer 23 can be expressed as follows according to the stress-strain relationship:

$$K = \frac{σ}{ε} = \frac{F \cdot A}{ε} = \frac{mg}{A \cdot ε} ; \qquad ( 2 )$$

finally, by substituting Formula (2) into Formula (1), the relationship between the current (I) of the coil 242 and the mass change and strain of the carried object can be obtained, as shown in Formula (3):

$$I = \frac{{I}_{0}}{Δ K} ( \frac{mg}{A \cdot ε} - \frac{{E}_{0} \cdot A}{L} ) ; \qquad ( 3 )$$

it can be seen from Formula (3) that when changes in the magnetorheological effect ΔK caused by compression deformation of the magnetorheological elastomer 23 is not taken into account, only the mass of the carried object (mg) in Formula (3) and the current (I) of the coil 242 are variable, and in order to keep the strain E unchanged, the mass of the carried object (mg) and the current (I) of the coil 242 have a one-to-one correspondence (that is, a corresponding current value of the coil 242 exists for any determined mass of the carried object (mg) to ensure that the strain E keeps unchanged, such that the vibration isolator is always in the quasi-zero stiffness equilibrium state). However, in an actual application process, the magnetorheological effect ΔK of the magnetorheological elastomer 23 increases with an increase in applied magnetic field intensity, and also increases with a decrease in excitation amplitude, therefore, the mass of the carried object (mg) and the current (I) of the coil 242 are not a simple one-to-one correspondence, but changes with the working conditions. Therefore, it is impossible to obtain the current loaded on the coil 242 corresponding to a fixed mass of the carried object, that is, it is impossible to accurately control the quasi-zero stiffness equilibrium state of the vibration isolator by a table look-up method, ignoring the influence of changes in the magnetorheological effect ΔK will result in a large error, which is also a reason that the conventional quasi-zero stiffness vibration isolator is difficult to return to the quasi-zero stiffness equilibrium state again through precise control when the load changes.

Based on the above reasons, the control method provided by the present disclosure does not focus on the specific relationship between the mass of the carried object (mg) and the current (I) of the coil 242, but focuses on the relationship between the strain magnitude (P) and the current (I) of the coil 242; and when the strain magnitude ε(t) measured by the strain detection device 26 reaches the target strain magnitude ε, the accurate quasi-zero stiffness equilibrium state that the intelligent vibration isolator can be reached will be determined.

In order to make the intelligent vibration isolator be always in the quasi-zero stiffness equilibrium position, the strain magnitude ε(t) obtained in real time needs to be accurately controlled, and in the present disclosure, the currently measured strain magnitude ε(t) is continuously approached to the target strain magnitude ε by adjusting the magnitude of current of the coil 242 of the electromagnet 24, and the control of the quasi-zero stiffness equilibrium state is finally realized. When the currently measured strain magnitude is less than the target strain magnitude, the current stiffness of the magnetorheological elastomer 23 is too large, which is insufficient for the negative stiffness mechanism 25 of the intelligent vibration isolator to reach the quasi-zero stiffness equilibrium position, and a current value is sequentially reduced until the strain magnitude ε(t) approaches the target strain magnitude ε. In this embodiment, a single current reduction value is set to 0.1 A; when the currently measured strain magnitude ε is greater than the target strain magnitude ε, the current stiffness of the magnetorheological elastomer 23 is too small, as a result, the end of the negative stiffness mechanism 25 connected to the supporting platform 22 appears below the quasi-zero stiffness equilibrium position, the current value needs to be increased sequentially until the strain magnitude ε(t) approaches the target strain magnitude ε. In this embodiment, a single current increase value is set to 0.1 A. When the mass of the carried object changes each time, the intelligent vibration isolator is always in the quasi-zero stiffness equilibrium state based on the above adjustment principle, thereby achieving the best vibration isolation performance.

As a preferred embodiment, in the step S2, the magnitude of current of the electromagnet 24 is adjusted through a PID algorithm, and the PID algorithm includes the following steps.
obtain a strain magnitude ε of the magnetorheological elastomer 23 when the intelligent vibration isolator is in an initial quasi-zero stiffness equilibrium state, and set the strain magnitude as a target strain magnitude;
calculate and adjust an output current (u(t)) according to Formula (4);

$$u ( t ) = {k}_{P} e ( t ) + {k}_{I} \int e ( t ) dt + {k}_{d} \frac{de ( t )}{dt} ; \qquad ( 4 )$$

where e(t) represents a strain magnitude error signal of the magnetorheological elastomer 23, e(t)=ε(t)−ε; and k_{P} represents a proportional coefficient, k_{I} represents an integral coefficient, and k_{d} represents a differential coefficient.

Specifically, the strain magnitude ε(t) measured by the strain gauge disposed on the outer wall of the magnetorheological elastomer 23 of the intelligent vibration isolator is taken as a control target, the magnitude of current is continuously adjusted, a difference e(t) between the strain magnitude ε(t) at the current moment and the set target strain magnitude ε is taken as an input of a control system, driving current u(t) of the controller 3 is taken as an output, and the magnitude of current of the energised coil 242 is continuously adjusted to change the stiffness of the magnetorheological elastomer 23 until the strain magnitude ε(t) measured on the magnetorheological elastomer 23 at the current moment approaches the target strain magnitude ε, and adjustment of the quasi-zero stiffness equilibrium state is finally achieved.

The PID algorithm is a control algorithm based on the feedback principle, the controlled physical quantity is controlled through three coefficients of proportional, integral and differential according to a difference between the controlled physical quantity and the set value; and the three coefficients are an error proportion part k_{P}e(t), an integral part k_{I}∫e(t)dt and a differential part

$${k}_{d} \frac{de ( t )}{dt} .$$

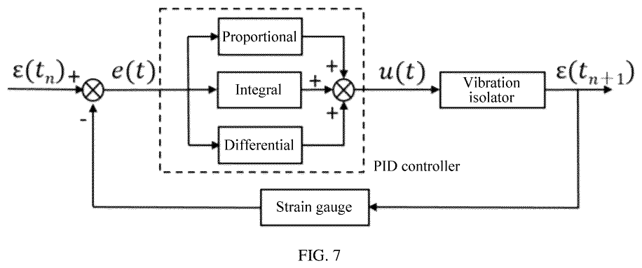

Three parameters: k_{P}, k_{I} and k_{d} are determined according to the expression of system transfer function, such that the magnitude of current of the coil 242 in the intelligent vibration isolator is adjusted. The specific schematic diagram of the control principle is shown in FIG. 7.

The PID algorithm combines three regulation rules of proportional, integral, and differential coefficients together, so long as strength of the three items are coordinated properly, adjustment can not only be performed quickly, residual errors can be eliminated, and a satisfactory control effect can also be obtained.

The proportion part (k_{P}): the greater the difference between a control variable and a set value is, the greater the amplitude of the feedback signal becomes, and the greater the change of the control variable will be; and the greater the proportional coefficient is, the greater the contribution of the control variable to the error becomes.

The integral part (k_{I}): integral control involves the summation and integration of error signals, and influence of the error signals within a certain period of time will be taken into account; and the integral control can eliminate static errors, such that the system can reach a stable state.

The differential part (k_{d}): differential control involves the adjustment of a speed of change of the control quantity by differentiating the error signals, such that the control variable becomes smoother; and the differential control can effectively eliminate dynamic errors of the system and improve a response speed of the system.

In the PID control, the proportional function is to perform basic control; the differential function is to accelerate a control speed of the system; and the integral function is to eliminate the static errors. As long as the three regulation rules, that is, proportional, integral, and differential, are coordinated properly, adjustment can not only be performed quickly, residual errors can be eliminated, and a satisfactory control effect can also be obtained.

When k_{P} is small, the system is more sensitive to the introduction of differential and integral links, the integral may cause overshoot, the differential may cause oscillation, and the overshoot may also increase when the oscillation is violent.

When k_{P} increases, the overshoot caused by the hysteresis of the integral link gradually decreases, in which case, when it is desired to continue to reduce the overshoot, the differential link can be properly introduced. When k_{P} is continuously increased, the system may be less stable. Therefore, k_{P} is introduced while k_{P} is increased to reduce overshoot, and it can be ensured that k_{P} can obtain better steady-state characteristics and dynamic performance when it is not very large.

When k_{P} is small, the integral link should not be too large, and when k_{P} is larger, the integral link should not be too small (otherwise, the regulation time will be very long). When a segmented PID is used, the integral is separated under appropriate conditions, and a better control effect can be achieved, this is because the hysteresis of the system is eliminated when the steady-state error is about to meet the requirements. Therefore, the system overshoot can be significantly reduced.

It can be understood that the same or similar parts in the above embodiments can be referred to each other, and the content that is not described in detail in some embodiments can be referred to the same or similar parts in other embodiments.

It should be noted that the terms “first,” “second,” and the like, in the description of the present disclosure are used for descriptive purposes only, and cannot be construed as indicating or implying relative importance. In addition, “a plurality of” in the description of the present disclosure means two or more, unless otherwise expressly specified.

In the statement of the description, description with reference to terms of “one embodiment”, “some embodiments”, “example(s)”, “specific example”, or “some examples” means that specific features, structures, materials, or characteristics described in combination with the embodiment(s) or example(s) are included in at least one embodiment or example of the present disclosure. In the description, the schematic descriptions of the above terms do not necessarily refer to the same embodiment or example. Moreover, the specific feature, structure, material or characteristics described may be combined in a suitable manner in any one or more embodiments or examples.

Although the embodiments of the disclosure have been shown and described above, it can be understood that the above embodiments are exemplary, and cannot be construed as limitations of the disclosure, and those of ordinary skill in the art make can make changes, modifications, substitutions and alterations to the above embodiments with the scope of the disclosure.

What it claimed is:

1. An intelligent vibration isolator, comprising a base, a vibration isolation mechanism disposed inside the base, and a controller; wherein
the base comprises a bottom plate and a supporting sleeve disposed on the bottom plate;
the vibration isolation mechanism comprises a load platform, a supporting platform, a magnetorheological elastomer and an electromagnet which are sequentially and coaxially disposed from top to bottom;
the vibration isolation mechanism is provided with at least three negative stiffness mechanisms, one end of each of the negative stiffness mechanism is hinged to an outer wall of the supporting platform, and the other end thereof is hinged to an inner wall of the supporting sleeve, and the at least three negative stiffness mechanisms are uniformly distributed in a circumferential direction of the supporting platform between the inner wall of the supporting sleeve and the outer wall of the supporting platform;
the electromagnet is disposed in a middle of the bottom plate and is electrically connected to the controller;
a strain detection device is disposed on an outer wall of the magnetorheological elastomer for detecting strain magnitude generated by the magnetorheological elastomer in real time and feeding the strain magnitude back to the controller;
the controller adjusts and controls a magnitude of current of the electromagnet in real time according to received strain magnitude to control vertical stiffness of the intelligent vibration isolator, such that the intelligent vibration isolator maintains a quasi-zero stiffness equilibrium state; and
the magnetorheological elastomer is a variable positive stiffness mechanism and is connected in parallel to the negative stiffness mechanisms to form a quasi-zero stiffness system of the intelligent vibration isolator.

2. The intelligent vibration isolator according to claim 1, wherein each negative stiffness mechanism comprises a telescopic rod assembly and a spring sleeved outside the telescopic rod assembly, the telescopic rod assembly has a first end and a second end disposed opposite to each other, the first end of the telescopic rod assembly is hinged to the outer wall of the supporting platform, and the second end of the telescopic rod assembly is hinged to the inner wall of the supporting sleeve.

3. The intelligent vibration isolator according to claim 2, wherein the telescopic rod assembly comprises a first supporting rod and a second supporting rod, and the second supporting rod is slidably disposed inside the first supporting rod in an axis direction of the first supporting rod.

4. The intelligent vibration isolator according to claim 1, wherein the electromagnet comprises a supporting iron core and a coil wound around an outer wall of the supporting iron core; and the supporting iron core is a cylindrical structure, a side wall groove is formed on a side wall of the supporting iron core in a circumferential direction of the supporting iron core, and the coil is wound inside the side wall groove; and
a top groove is formed on a top of the supporting iron core, one end of the magnetorheological elastomer is disposed inside the top groove, and the other end of the magnetorheological elastomer is connected to the supporting platform.

5. The intelligent vibration isolator according to claim 2, wherein a first hinge seat is disposed on the outer wall of the supporting platform, a first pin shaft is rotatably disposed on the first hinge seat, and the first end of the telescopic rod assembly is connected to the first pin shaft; and
a second hinge seat is correspondingly disposed on the inner wall of the supporting sleeve, a second pin shaft is rotatably disposed on the second hinge seat, and the second end of the telescopic rod assembly is connected to the second pin shaft.

6. A control method of the intelligent vibration isolator according to claim 1, comprising following steps:
S1: when a load on the load platform changes, the strain detection device obtaining the strain magnitude ε(t) of the magnetorheological elastomer in real time, and the negative stiffness mechanism being in a disequilibrium position; and
S2: adjusting the magnitude of current of the electromagnet to change a stiffness value of the magnetorheological elastomer until the strain magnitude ε(t) obtained in the step S1 approaches a target strain magnitude ε, the negative stiffness mechanism restoring the equilibrium position, and the intelligent vibration isolator being in the quasi-zero stiffness equilibrium state.

7. The control method according to claim 6, wherein in the step S2, the magnitude of current of the electromagnet is adjusted through a Proportional-Integral-Derivative (PID) algorithm, and the PID algorithm comprises following steps:
obtaining a strain magnitude ε of the magnetorheological elastomer when the intelligent vibration isolator is in an initial quasi-zero stiffness equilibrium state, and setting the strain magnitude as a target strain magnitude; and
calculating and adjusting an output current (u(t)) according to following formula:
$$u ( t ) = {k}_{P} e ( t ) + {k}_{I} \int e ( t ) dt + {k}_{d} \frac{de ( t )}{dt}$$
wherein, in the formula, e(t) represents a strain magnitude error signal of the magnetorheological elastomer, e(t)=ε(t)−ε; and k_{P} represents a proportional coefficient, k_{I} represents an integral coefficient, and k_{d} represents a differential coefficient.

8. The control method according to claim 7, wherein in the step S2, when the strain magnitude ε(t) obtained in real time is less than the target strain magnitude ε, stiffness of the magnetorheological elastomer is too large, in which case, a current value is sequentially reduced until the strain magnitude ε(t) approaches the target strain magnitude ε; and
when the strain magnitude ε(t) obtained in real time is greater than the target strain magnitude ε, the stiffness of the magnetorheological elastomer is too small, in which case, the current value is sequentially increased until the strain magnitude ε(t) approaches the target strain magnitude ε.

9. The control method according to claim 8, wherein a single current reduction value is set to 0.1 A, and a single current increase value is set to 0.1 A.
